(19) United States
(12) Patent Application Publication
(10) Pub. No.: US 2009/0202150 A1
(43) Pub. Date: Aug. 13, 2009

(54) VARIABLE RESOLUTION MODEL BASED IMAGE SEGMENTATION

(75) Inventors: Maxim Fradkin, Puteaux (FR); Jean-Michel Rouet, Paris (FR); Franck Laffargue, Poissy (FR)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V,, Eindhoven (NL)

(21) Appl. No.: 12/305,433

(22) PCT Filed: Jun. 25, 2007
(86) PCT No.: PCT/IB2007/052447

§ 371 Date: Dec. 18, 2008

(30) Foreign Application Priority Data
Jun. 28, 2006 (EP) 06300730.6

(51) Int. Cl. G06T 5/00

(52) U.S. Cl. 382/173

(57) ABSTRACT

The invention relates to system (100) for segmenting an image dataset based on a deformable model for modeling an object in the image dataset, utilizing a coarse mesh for adapting to the image dataset and a fine mesh for extracting detailed information from the image dataset, the system comprising an initialization unit (110) for initializing the coarse mesh in an image dataset space, a construction unit (120) for constructing the fine mesh in the image dataset space based on the initialized coarse mesh, a computation unit (130) for computing an internal force field on the coarse mesh and an external force field on the coarse mesh, wherein the external force is computed based on the constructed fine mesh and the scalar field of intensities, and an adaptation unit (140) for adapting the coarse mesh to the object in the image dataset, using the computed internal force field and the computed external force field, thereby segmenting the image dataset. Since only the coarse mesh is adapted to the image dataset, keeping the modeled object surface smooth does not require a smoothing of the surface over large neighboring areas, and therefore the adaptation of the coarse mesh is much faster than the adaptation of the fine mesh. Advantageously, the proposed technique can be easily integrated into existing frameworks of model-based image segmentation.

### FIELD OF THE INVENTION

The invention relates to the field of image segmentation and more specifically to image segmentation based on deformable models.

### BACKGROUND OF THE INVENTION

An implementation of image segmentation based on deformable models is described by H. Delingette in an article entitled “General object reconstruction based on simplex Meshes” in the “International Journal on Computer Vision, vol. 32, no. 2, pp. 111-146, 1999, hereinafter referred to as Ref. 1. This paper presents a method of adapting a simplex mesh to a three-dimensional (3D) object. Simplex meshes have a simple topology wherein each vertex of the simplex mesh is connected to three neighboring vertices of the simplex mesh. The adaptation of a simplex mesh is driven by external forces. Each simplex mesh vertex is attracted by an external force towards the respective image feature in the 3D image data. Image features are computed on the basis of local gradients of the image intensity field. Elastic behavior of simplex meshes, which constrains the deformation driven by external forces, is modeled by internal forces, e.g. by internal forces that minimize the local mesh curvature. The simplex mesh is iteratively adapted until the external and internal forces at each vertex cancel each other out. A refinement process for increasing the mesh resolution at highly curved parts is also described in Ref. 1. A fine-resolution mesh comprises more vertices and thus can utilize more information comprised in the image data. However, keeping the model surface smooth is computationally more demanding when a fine mesh is used.

### SUMMARY OF THE INVENTION

It would be advantageous to segment an image data utilizing fine-resolution information comprised in said image data while effectively controlling smoothness of the computed model surface represented by a mesh without a substantial increase of computational cost. Computational cost comprises the processor bandwidth and the computation time. However, if one uses very fine surface sampling, i.e. fine-resolution meshes, keeping the model surface smooth may significantly increase computational cost because the model surface needs to be smoothed over large neighboring areas.

To better address this concern, in an aspect of the invention, a system for segmenting an image dataset based on a deformable model for modeling an object in the image dataset, utilizing a coarse mesh for adapting to the image dataset and a fine mesh for extracting detailed information from the image dataset, comprises:
an initialization unit for initializing the coarse mesh in an image dataset space;
a construction unit for constructing the fine mesh in the image dataset space based on the initialized coarse mesh;

a computation unit for computing an internal force field on the coarse mesh and an external force field on the coarse mesh, wherein the external force is computed based on the constructed fine mesh and the scalar field of intensities; and
an adaptation unit for adapting the coarse mesh to the object in the image dataset, using the computed internal force field and the computed external force field, thereby segmenting the image dataset.

Constructing the fine mesh in the image dataset space is based on the initialized coarse mesh and may be carried out, for example, by means of a subdivision scheme with control points comprised in the coarse mesh. The fine mesh is used by the computation unit to find features in the image dataset and to compute the external force field on the coarse mesh based on the found features. Therefore, even when the image features are sparse, the use of the fine mesh can still achieve that said features are not missed. The coarse mesh is then adapted to the image dataset by the adaptation unit using the external and the internal force fields computed by the computation unit. Since only the coarse mesh is adapted to the image dataset, keeping the modeled object surface smooth does not require a smoothing of the surface over large neighboring areas. Therefore, the computational cost of adapting the coarse mesh to an object in the image dataset is significantly lower than that of adapting the fine mesh to an object in the image dataset. The reduction in the computational cost of the adaptation far exceeds the extra computational cost added by the construction of the fine mesh by means of, for example, a subdivision scheme for subdividing the coarse mesh. Advantageously, the proposed technique can be easily integrated into existing frameworks of model-based image segmentation.

In an embodiment of the system, the fine mesh is constructed on the basis of a subdivision scheme of the coarse mesh. There are many useful subdivision schemes, e.g. the Doo-Sabin's scheme, the Catmull-Clark's scheme, and the Loop's scheme, which may be advantageously employed by the system. Most of the subdivision schemes are fast and therefore further reduce the computational cost of the segmentation task.

In an embodiment of the system, the system further comprises a determination unit for determining a resolution of the fine mesh. The determination unit is capable of determining an optimum resolution of the fine mesh. This resolution may be a function of the image data resolution and/or of the expected feature size. In a further embodiment of the system, an additional consideration is to take into account the computational cost: the finer the resolution, the higher the computational cost. Alternatively, the resolution may be determined on the basis of user input data such as a user-defined subdivision level.

In a further aspect of the invention, an image acquisition apparatus comprises a system for segmenting an image dataset based on a deformable model for modeling an object in the image dataset, utilizing a coarse mesh for adapting to the image dataset and a fine mesh for extracting detailed information from the image dataset, the system comprising:

an initialization unit for initializing the coarse mesh in an image dataset space;

a construction unit for constructing the fine mesh in the image dataset space based on the initialized coarse mesh;

a computation unit for computing an internal force field on the coarse mesh and an external force field on the coarse mesh, wherein the external force is computed based on the constructed fine mesh and the scalar field of intensities; and

an adaptation unit for adapting the coarse mesh to the object in the image dataset, using the computed internal force field and the computed external force field, thereby segmenting the image dataset.

In a further aspect of the invention, a workstation comprises a system for segmenting an image dataset based on a deformable model for modeling an object in the image dataset, utilizing a coarse mesh for adapting to the image dataset and a fine mesh for extracting detailed information from the image dataset, the system comprising:

an initialization unit for initializing the coarse mesh in an image dataset space;

a construction unit for constructing the fine mesh in the image dataset space based on the initialized coarse mesh;

a computation unit for computing an internal force field on the coarse mesh and an external force field on the coarse mesh wherein the external force is computed based on the constructed fine mesh and the scalar field of intensities; and

an adaptation unit for adapting the coarse mesh to the object in the image dataset, using the computed internal force field and the computed external force field, thereby segmenting the image dataset.

In a further aspect of the invention, a method of segmenting an image dataset based on a deformable model for modeling an object in the image dataset, utilizing a coarse mesh for adapting to the image dataset and a fine mesh for extracting detailed information from the image dataset, comprises:

an initialization step for initializing the coarse mesh in an image dataset space;

a construction step for constructing the fine mesh in the image dataset space based on the initialized coarse mesh;

a computation step for computing an internal force field on the coarse mesh and an external force field on the coarse mesh, wherein the external force is computed based on the constructed fine mesh and the scalar field of intensities; and

an adaptation step for adapting the coarse mesh to the object in the image dataset, using the computed internal force field and the computed external force field, thereby segmenting the image dataset.

In a further aspect of the invention, a computer program product to be loaded by a computer arrangement comprises instructions for segmenting an image dataset based on a deformable model for modeling an object in the image dataset, utilizing a coarse mesh for adapting to the image dataset and a fine mesh for extracting detailed information from the image dataset, the computer arrangement comprising a processing unit and a memory, which computer program product, after being loaded, provides said processing unit with the capability to carry out the following tasks of:
initializing the coarse mesh in an image dataset space;
constructing the fine mesh in the image dataset space based on the initialized coarse mesh;

computing an internal force field on the coarse mesh and an external force field on the coarse mesh, wherein the external force is computed based on the constructed fine mesh and the scalar field of intensities; and

adapting the coarse mesh to the object in the image dataset, using the computed internal force field and the computed external force field, thereby segmenting the image dataset.

Modifications and variations thereof, of the image acquisition apparatus, of the workstation, of the method, and/or of the computer program product, which correspond to modifications of the system and variations thereof as described above can be implemented by those skilled in the art on the basis of the present description.

Those skilled in the art will appreciate that the method may be applied to three-dimensional (3D) and to two-dimensional (2D) image datasets generated by various acquisition modalities such as, but not limited to, conventional X-Ray, Computed Tomography (CT), Magnetic Resonance Imaging (MRI), Ultrasound (US), Positron Emission Tomography (PET), Single Photon Emission Computed Tomography (SPECT), and Nuclear Medicine (NM).

### BRIEF DESCRIPTION OF THE DRAWINGS

These and other aspects of the invention will become apparent from and will be elucidated with respect to the implementations and embodiments described hereinafter and with reference to the accompanying drawings, wherein:

FIG. 1 schematically shows a block diagram of an exemplary embodiment of the system;

FIG. 2 shows a flowchart of an exemplary implementation of the method;

FIG. 3 shows an exemplary simplex mesh;

FIG. 4 illustrates the triangular mesh dual to the simplex mesh;

FIG. 5 illustrates the first level subdivision of the dual mesh;

FIG. 6 illustrates the second level subdivision of the dual mesh;

FIG. 7 shows exemplary results of cardiac segmentation in a noisy 3D US image;

FIG. 8 schematically shows an exemplary embodiment of the image acquisition apparatus; and

FIG. 9 schematically shows an exemplary embodiment of the workstation.

The same reference numerals are used to denote similar parts throughout the Figures.

### DETAILED DESCRIPTION OF EMBODIMENTS

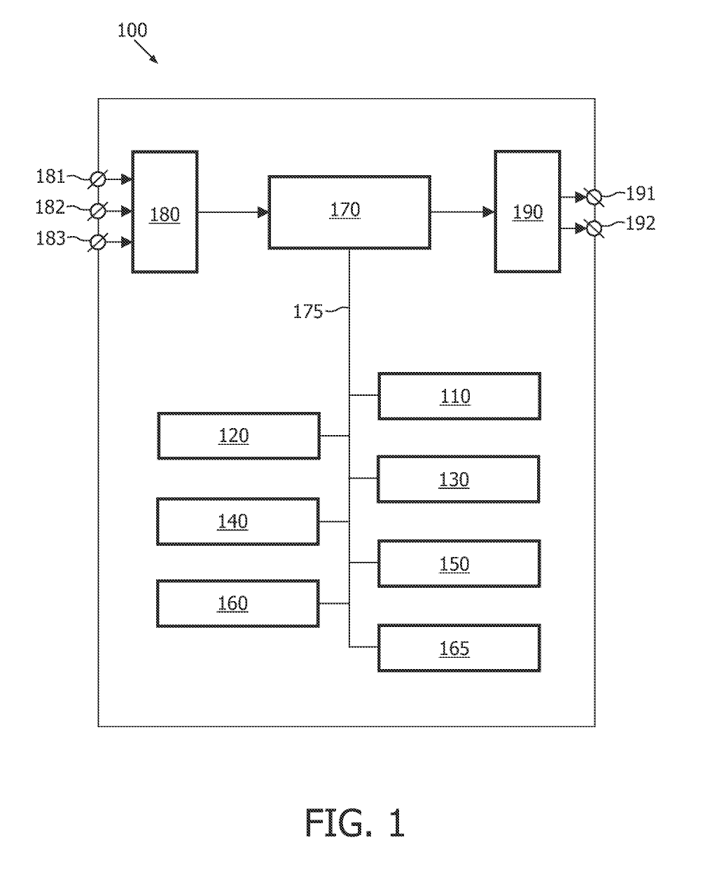

FIG. 1 schematically shows a block diagram of an exemplary embodiment of the system 100 for segmenting an image dataset based on a deformable model for modeling an object in the image dataset, utilizing a coarse mesh for adapting to the image dataset and a fine mesh for extracting detailed information from the image dataset, the system 100 comprising:

an initialization unit 110 for initializing the coarse mesh in an image dataset space;

a construction unit 120 for constructing the fine mesh in the image dataset space based on the initialized coarse mesh;

a computation unit 130 for computing an internal force field on the coarse mesh and an external force field on the coarse mesh, wherein the external force is computed based on the constructed fine mesh and the scalar field of intensities; and

an adaptation unit 140 for adapting the coarse mesh to the object in the image dataset, using the computed internal force field and the computed external force field, thereby segmenting the image dataset.

The exemplary embodiment of the system 100 further comprises the following optional units:

a determination unit 150 for determining a resolution of the fine mesh;

a control unit 160 for controlling the workflow in the system 100;

a user interface 165 for communicating with a user of the system 100; and

a memory unit 170 for storing data.

In the exemplary embodiment of the system 100, there are three input connectors 181, 182 and 183 for the incoming data. The first input connector 181 is arranged to receive data coming in from data storage such as, but not limited to, a hard disk, a magnetic tape, a flash memory, or an optical disk. The second input connector 182 is arranged to receive data coming in from a user input device such as, but not limited to, a mouse or a touch screen. The third input connector 183 is arranged to receive data coming in from a user input device such as a keyboard. The input connectors 181, 182 and 183 are connected to an input control unit 180.

In the exemplary embodiment of the system 100, there are two output connectors 191 and 192 for the outgoing data. The first output connector 191 is arranged to output the data to data storage such as a hard disk, a magnetic tape, a flash memory, or an optical disk. The second output connector 192 is arranged to output the data to a display device. The output connectors 191 and 192 receive the respective data via an output control unit 190.

Those skilled in the art will understand that there are many ways to connect input devices to the input connectors 181, 182 and 183 and output devices to the output connectors 191 and 192 of the system 100. These ways comprise, but are not limited to, a wired and a wireless connection, a digital network such as, but not limited to, a Local Area Network (LAN) and a Wide Area Network (WAN), the Internet, a digital telephone network, and an analog telephone network.

In the exemplary embodiment of the system 100, the system 100 comprises a memory unit 170. The system 100 is arranged to receive input data from external devices via any of the input connectors 181, 182, and 183 and to store the received input data in the memory unit 170. Loading the input data into the memory unit 170 allows a quick access to relevant data portions by the units of the system 100. The input data may comprise, for example, the image dataset. The memory unit 170 may be implemented by devices such as, but not limited to, a Random Access Memory (RAM) chip, a Read Only Memory (ROM) chip, and/or a hard disk drive and a hard disk. The memory unit 170 may be further arranged to store the output data. The output data may comprise, for example, the adapted coarse mesh. The memory unit 170 is also arranged to receive data from and to deliver data to the units of the system 100, comprising the initialization unit 110; the construction unit 120, the computation unit 130, the adaptation unit 140, the determination unit 150, the control unit 160, and the user interface 165 via a memory bus 175. The memory unit 170 is further arranged to make the output data available to external devices via any of the output connectors 191 and 192. Storing the data from the units of the system 100 in the memory unit 170 may advantageously improve the performance of the units of the system 100 as well as the rate of transfer of the output data from the units of the system 100 to external devices.

Alternatively, the system 100 may not comprise the memory unit 170 and the memory bus 175. The input data used by the system 100 may be supplied by at least one external device, such as an external memory or a processor, connected to the units of the system 100. Similarly, the output data produced by the system 100 may be supplied to at least one external device, such as an external memory or a processor, connected to the units of the system 100. The units of the system 100 may be arranged to receive the data from each other via internal connections or via a data bus.

In the exemplary embodiment of the system 100 shown in FIG. 1, the system 100 comprises a control unit 160 for controlling the workflow in the system 100. The control unit may be arranged to check a termination condition. If the termination condition is satisfied, the system 100 may be arranged to perform final tasks and terminate the segmentation of the image dataset. Alternatively, a control function may be implemented in other units of the system 100.

In the exemplary embodiment of the system 100 shown in FIG. 1, the system 100 comprises a user interface 165 for communicating with the user of the system 100. The user interface 165 may be arranged to prompt the user for and to accept a user selection of the image dataset and of the fine mesh resolution, for example. The user interface 165 may be further arranged to provide means for displaying a view rendered from the image dataset and/or for displaying the initialized and the adapted coarse mesh. Optionally, the user interface may receive a user selection of one of a plurality of modes of operation of the system 100. In an exemplary mode, the system 100 may be arranged to use a particular coarse mesh, e.g. a simplex or a triangular coarse mesh. The modes may be implemented by the system 100. Those skilled in the art will understand that more functions may be advantageously implemented in the user interface 165 of the system 100.

Optionally, in a further embodiment of the system 100, the system 100 may comprise an input device such as a mouse or a keyboard and/or a an output device such as a display Those skilled in the art will understand that a large number of input and output devices exist that can be advantageously comprised in the system 100.

In the embodiment of the system 100 depicted in FIG. 1, the system 100 obtains the image dataset and the coarse mesh and stores them in the memory unit 170. The coarse mesh is initialized in the image dataset space by the initialization unit 110. The image dataset space is determined based on the range of spatial coordinates of voxels comprised in the image dataset. The initialized coarse mesh comprises coordinates of the vertices of the coarse mesh in said image dataset space. The construction unit 120 is arranged to use the initialized coarse mesh or an adapted coarse mesh, adapted by the adaptation unit 140, to construct a fine mesh. For example, the coarse mesh is subdivided in accordance with an appropriate subdivision scheme. The vertices of the coarse mesh are used as control points of the subdivision. Optionally, the system 100 further comprises the determination unit 150 for determining the resolution of the fine mesh, e.g. the level of the finest subdivision. The computation unit 130 uses the constructed fine mesh to compute an external force field on the coarse mesh. The external force field is determined on the basis of the scalar field of intensities comprised in the image dataset and on the basis of the constructed fine mesh. The computation unit 130 is further arranged to compute an internal force field on the coarse mesh. The internal force field depends on the geometry of the coarse mesh. The adaptation unit 140 uses the external and internal force fields to compute the deformation of the coarse mesh in terms of the new coordinates of the vertices of the coarse mesh, thus adapting the coarse mesh to the image dataset to model the object in the image dataset. The control unit 160 is arranged to control the workflow in the system 100. The control unit 160 receives control data from the units of the system and provides the units of the system with control data. The provided control data determine the operation of the units of the system 100. The control unit 160 may be arranged, for example, to examine whether the adapted coarse mesh satisfies an adaptation termination criterion. If the adapted coarse mesh satisfies an adaptation termination criterion, the control unit may be arranged to terminate the segmentation of the image dataset. If not, the control unit may be arranged to begin the next iteration of the adaptation cycle by requesting the construction unit 120 to construct the fine mesh on the basis of the adapted coarse mesh.

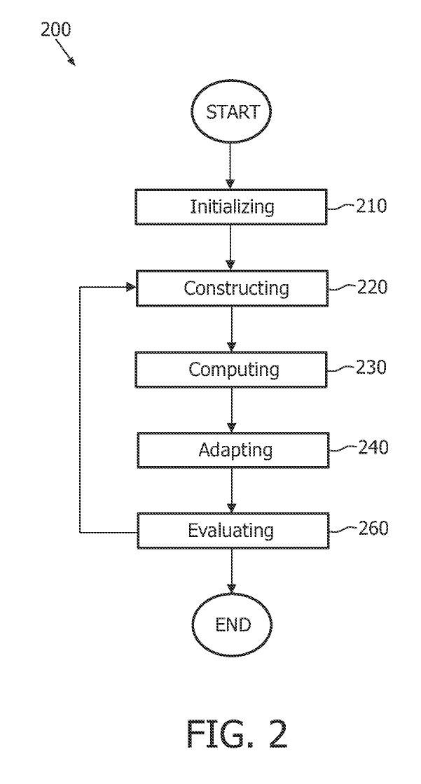

FIG. 2 shows a flowchart of an exemplary implementation of the method 200 of segmenting an image dataset based on a deformable model for modeling an object in the image dataset utilizing a coarse mesh for adapting to the image dataset and a fine mesh for extracting detailed information from the image dataset. In an initialization step 210, the coarse mesh is initialized in the image dataset space based on the scalar field of intensities. After the initialization step 210, the method 100 continues to a construction step 220 for constructing the fine mesh in the image dataset space based on the initialized coarse mesh. After the construction step 220, the method 100 continues to a computation step 230 for computing an internal force field on the coarse mesh and an external force field on the coarse mesh, wherein the external force is computed based on the constructed fine mesh and the scalar field of intensities. After the computation step 230, the method 200 continues to an adaptation step 240 for adapting the coarse mesh to the object in the image dataset, using the computed internal force field and the computed external force field. After the adaptation step 240, the method 200 continues to an evaluation step 250 for evaluating the adaptation results. If the adaptation result is satisfactory, i.e. if the adaptation result satisfies an evaluation condition, the method 200 terminates the segmentation. Optionally, the method 200 further constructs the fine mesh based on the adapted coarse mesh in the evaluation step 260 before terminating. If the adaptation result is not satisfactory, the method 200 continues to the construction step 220 for constructing the fine mesh in the image dataset space based on the adapted coarse mesh.

The initialization unit 110 is arranged to initialize the coarse mesh in an image dataset space. The topology of the coarse mesh may be predefined, e.g. a deformable model comprising a definition of the mesh topology may be comprised in the input to the system 100. Alternatively, the topology of the coarse mesh may be semi-automatically, i.e. with a user input, or automatically, i.e. with no user input, determined by the initialization system based on of the image dataset. Typically, the initialization comprises a manual placement of the coarse mesh and fitting of the mesh to the model object with a global transformation. First the user manually aligns the coarse model with a few, for example anatomical, landmarks identified in the image dataset and displayed in a display connected to the system 100. Second, the positioned coarse mesh is fitted to the object in the image dataset with the use of the global transformation of the image dataset space. Typical transformations used to map the coarse mesh onto the object in the image dataset comprise rigid transformations, similarity transformations, and affine transformations. A method of fitting a simplex mesh to a 3D image dataset is described by O. Gerard et al. in Section II-B of a publication entitled “Efficient model-based quantification of left ventricular function in 3D echocardiography” in IEEE Transactions on Medical Imaging, vol. 21, no. 2, 1059-1068, 2002, hereinafter referred to as Ref. 2. Those skilled in the art will be aware that various manual, semi-automatic, and automatic initialization methods are described in the literature and that these methods may depend on the topology of the coarse mesh used. The particular choice of initialization method does not limit the scope of the claims.

The construction unit 120 is arranged to construct the fine mesh in the image dataset space on the basis of the initialized or the adapted coarse mesh. One possible way of creating the fine mesh is to use a subdivision scheme that uses vertices of the coarse mesh as control points of the subdivision scheme. Several subdivision schemes are described in the literature. For example, the Doo-Sabin's scheme described by D. Doo and M. Sabin in an article entitled “Analysis of the behavior of recursive division surfaces near extraordinary points” in Computer Aided Design, 10(6), 356-360, 1978 and/or the Catmull-Clark's scheme described by E. Catmull and J. Clark in an article entitled “Recursively generated B-spline surfaces on arbitrary topological meshes” in Computer Aided Design, 10(6), 350-355, 1978 may be used. Selecting a subdivision scheme for implementation in the construction unit 120 is a system design decision. The selection of the subdivision scheme may depend on the topology of the coarse mesh representing the surface of the modeled object in the image dataset. Optionally, a plurality of subdivision schemes may be implemented in the construction unit 120. The subdivision scheme used may be interactively selected by a user, for example.

In an embodiment of the system 100, the coarse mesh is a triangular mesh. Faces of triangular meshes are triangles. Each face of a triangular mesh may be subdivided using the Loop's scheme. The Loop's scheme is described by Charles Loop in his Master Thesis entitled “Smooth subdivision surfaces based on triangles.” University of Utah, Department of Mathematics, 1987. Alternatively, the coarse mesh is a quad mesh comprising quadrilateral faces and each face of the coarse mesh is subdivided using the Doo-Sabin's scheme or the Catmull-Clark's scheme.

In an embodiment of the system 100, a fine mesh may be an arbitrary mesh. The construction unit 120 may further comprise means for mapping the fine mesh into the image dataset space on the basis of the initialized or adapted coarse mesh, for example by optimizing an internal force field defined on the fine mesh.

The computation unit 130 is arranged to compute an internal force field on the coarse mesh on the basis of the mesh geometry. A number of methods of computing an internal force field on a simplex mesh representing an object in an image dataset are described in Section 3.2 of Ref. 1. For example, the tangential internal force controls the vertex position relative to its neighbors connected by mesh edges to said vertex, and may be defined as a force proportional to the displacement of the vertex from the plane defined by its neighbors. Such an internal force minimizes curvature of the modeled surface.

The computation unit 130 is further arranged to compute an external force field on the coarse mesh using the constructed fine mesh and the scalar field of intensities. First, an external force field on the fine mesh is computed. For example, for each vertex of the fine mesh the target location of this vertex is computed. The target location of a vertex may be defined as the location of maximum variation in intensity, i.e. maximum gradient of the scalar field of intensities, on a search line. The search line may be the line crossing said vertex of the coarse mesh and substantially perpendicular to the surface defined by the neighboring vertices connected by mesh edges to said vertex. The intensity values on the search line may be derived from the scalar field of intensities comprised in the image dataset, for example using interpolation methods. The force defined by the target location may be a harmonic force proportional to the displacement of the vertex from its target location. This method is described in Section II-B of Ref. 2. More methods of computing external force fields on simplex meshes for modeling objects in image datasets are described in Section 3.2 of Ref. 1. Second, having computed the external force field on the fine mesh, the computation unit 130 is further arranged to compute the external force field on the coarse mesh. Each vertex of the coarse mesh is associated with vertices of the fine mesh. The association may be defined, for example, on the basis of the Euclidean distance of the vertex of the coarse mesh to the vertex of the fine mesh. All vertices of the fine mesh located within a sphere having a radius are defined as associated with the vertex of the coarse mesh at the center of the sphere. Said radius may be obtained from a user input device on the basis of a user input or may be determined by the computing unit 130 on the basis of the coarse mesh resolution. In a further implementation, the association may be defined on the basis of the topological distance. For example, a vertex of the fine mesh closest to the vertex of the coarse mesh is identified, and each vertex of the fine mesh for which the topological distance from this vertex to the identified vertex is less than a certain number is defined as associated with the vertex of the coarse mesh.

The external force acting on a vertex of the coarse mesh may be computed on the basis of the external forces defined on the vertices of the fine mesh associated with said vertex in one of the following ways:

the external force defined on a vertex of the coarse mesh is an average of the forces defined on the vertices of the fine mesh associated with said vertex;

the external force defined on a vertex of the coarse mesh is a weighted average of the forces defined on the vertices of the fine mesh associated with said vertex, where the weighting factors are based on a feature confidence;

the external force defined on a vertex of the coarse mesh is a force on majority vertices of the fine mesh associated with said vertex, based on a voting scheme.

The adaptation unit 140 uses the computed internal and external force fields to adapt the coarse mesh to the object in the image dataset. In one embodiment, the adaptation unit 140 is arranged to implement the method that uses the Lagrangian evolution equation described in Section 3.1 of Ref. 1 and in Section II-B of Ref. 2.

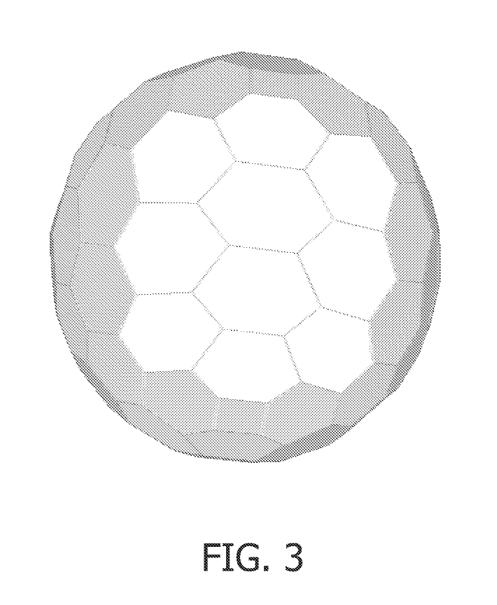

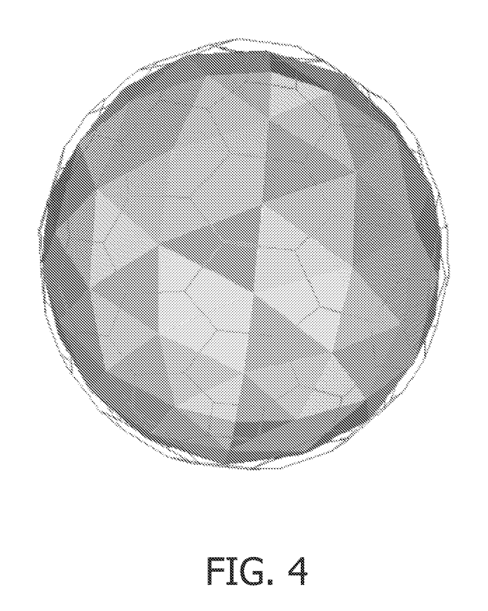

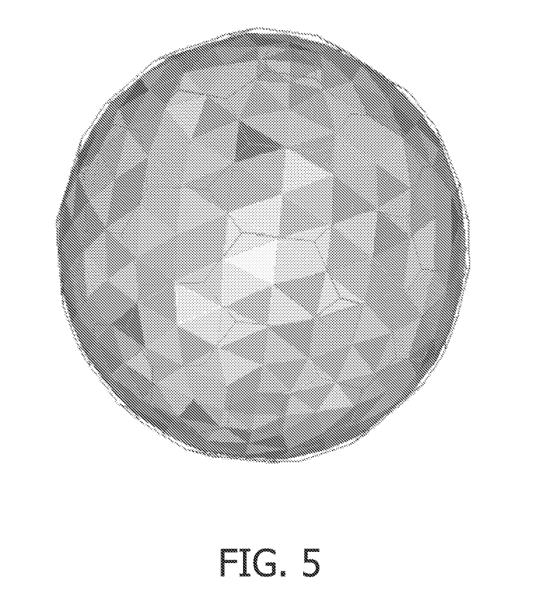

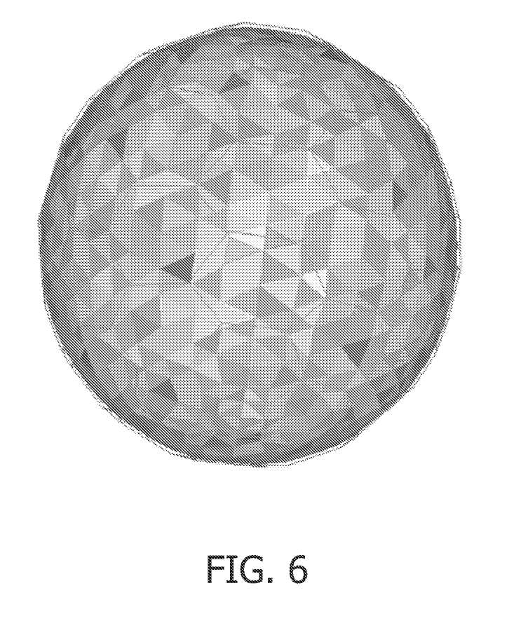

In an embodiment of the system 100, the coarse mesh is a simplex mesh. Each vertex of the simplex mesh is connected to three neighboring vertices of the simplex mesh. A subdivision of the simplex mesh may be carried out in a few steps. First the dual mesh of the given simplex mesh is constructed. Each vertex of the dual mesh is a barycenter, i.e. a center of mass, of a polygonal face of the simplex mesh. Typically, the mass of each vertex of the simplex mesh is set to one. The dual mesh is a triangular mesh wherein the edges connect barycenters of adjacent polygonal faces of the underlying simplex mesh. Each triangular face of the dual mesh corresponds to one vertex of the simplex mesh. Second, the Loop's scheme is used to subdivide the dual mesh. Each triangular face of the dual mesh is iteratively subdivided into a plurality of triangles. In the first iteration, each triangular face is subdivided into four triangles. In the second iteration, each triangle obtained in the first iteration is further subdivided into four triangles. The subdivision may by further iterated to obtain a desired resolution of the fine mesh. The level of the subdivision, i.e. the number of iterations of the Loop's algorithm, determines the resolution of the fine mesh. FIGS. 3 to 6 illustrate the described subdivision of a simplex mesh. FIG. 3 shows an exemplary simplex mesh. FIG. 4 illustrates the triangular mesh dual to the simplex mesh shown in FIG. 3. FIG. 5 illustrates the first level subdivision of the dual mesh shown in FIG. 4. FIG. 6 illustrates the second level subdivision of the dual mesh shown in FIG. 4.

The computation unit 130 is arranged to compute the external force field on the fine mesh. The vertices of the fine mesh associated with a vertex of the simplex mesh are used to compute the external force on said vertex of the simplex mesh. The external force on the vertex of the coarse mesh is the average of the forces computed on the vertices of the fine mesh associated with said vertex of the coarse mesh. Each vertex of the simplex coarse mesh is associated with one face of the triangular dual mesh defined by the barycenters of the three adjacent polygons that share said vertex of the simplex mesh. The vertices of the triangular fine mesh comprised in the subdivision of said triangular face are associated with said vertex of the simplex coarse mesh. The adaptation unit 140 uses the internal and external forces to compute the positions of the vertices of the coarse mesh using the Lagrangian evolution equation, thus adapting the coarse mesh to an object in the image dataset.

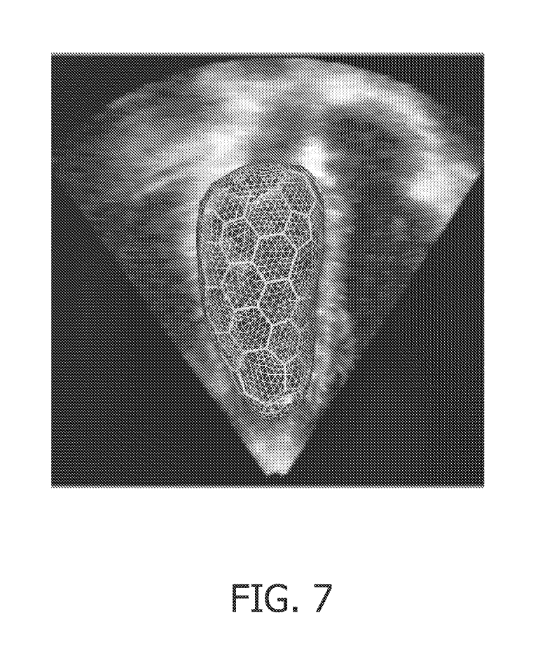

FIG. 7 shows exemplary results of a cardiac segmentation in a noisy 3D US image. The coarse mesh is shown in bold lines, while the fine mesh is shown in fine lines.

Those skilled in the art will understand that, in the absence of the damping force field, solving the Lagrangian evolution equation can be replaced by optimizing a sum of the internal and external energy terms. In an embodiment, solving the Lagrangian evolution equation is replaced with finding the minimum of said sum of the internal and external energy terms. An energy-based framework is described, for example, by J. Weese et al. in an article entitled “Shape constrained deformable models for 3D medical image segmentation” in Proc. IPMI, pp. 380-387, Springer 2001, hereinafter referred to as Ref. 3. Section 2 of Ref. 3 contains a description of the construction and of the optimization of said sum of the internal and external energy terms. Those skilled in the art will be able to modify the system 100 to be used in an energy-based framework. Thus, those skilled in the art will recognize that the choice of framework does not limit the scope of the claims.

In an embodiment of the system 100, the system further comprises a determination unit 150 for determining a resolution of the fine mesh. The determination unit renders it possible to determine an optimum resolution of the fine mesh. This resolution may be a function of the image data resolution and/or of the expected feature size. In a further embodiment of the system, an additional consideration is to take into account the computational cost: the finer the resolution, the higher the computational cost. Alternatively, the resolution may be determined on the basis of input data such as a user-defined subdivision level.

In an embodiment of the system 100, the control unit 160 is arranged to control the workflow of the system 100. The control unit obtains control data from the units of the system 100. For example, after completion of the adaptation step 240, the control unit may be arranged to compare the adapted positions of vertices of the coarse mesh computed by the adaptation unit 140 with the positions of vertices of the coarse mesh computed by the adaptation unit 140 in the preceding iteration of the method or by the initialization unit 110. If the obtained positions and the preceding positions are substantially equal, e.g. if the mutual difference is less than 5%, the control unit may be arranged to terminate the segmentation. The control unit may be further arranged to request the user interface 165 to prompt the user for an input and/or to request the user interface 165 to display the adapted coarse mesh, the constructed fine mesh, and/or a view rendered from the image dataset. Those skilled in the art are aware that there are many useful functions that may be advantageously implemented in the control unit 160

Although the described embodiments refer to a 3D image dataset, those skilled in the art will understand that the invention may also be applied to 2D image datasets. Those skilled in the art will be able to modify the units of the system and the steps of the method to implement the invention in the simpler case of 2D images. Those skilled in the art will also appreciate that various segmentation methods for segmenting an object in an image dataset by adapting a deformable model to said object may be advantageously exploited by the system 100 and that the segmentation method used does not limit the scope of the claims.

Those skilled in the art will understand that other embodiments of the system 100 are also possible. It is possible, among other options, to redefine the units of the system and to redistribute their functions. For example, in an embodiment of the system 100, the functions of the control unit 160 may be assigned to other units of the system 100. In a further embodiment of the system 100, there may be a plurality of construction units replacing the construction unit 130 of the previous embodiments of the system 100, where each construction unit may be arranged to apply a different subdivision scheme. The use of a subdivision scheme may be based on a user selection.

The units of the system 100 may be implemented by means of a processor. Normally, their functions are performed under the control of a software program product. During execution, the software program product is normally loaded into a memory, such as a RAM, and executed from there. The program may be loaded from a background memory, such as a ROM, hard disk, or magnetic and/or optical storage, or may be loaded via a network such as the Internet. Optionally, an application specific integrated circuit may provide the described functionality.

The order of the steps in the method 200 for segmenting an object in an image dataset is not mandatory, those skilled in the art may change the sequence of some of the steps or perform some steps concurrently, using threading models, multi-processor systems, or multiple processes without departing from the concept as intended by the present invention. Optionally, two or more steps of the method 100 of the current invention may be combined into one step. Optionally, a step of the method 100 of the current invention may be split up into a plurality of steps. Some steps of the method 100 are optional and may be omitted.

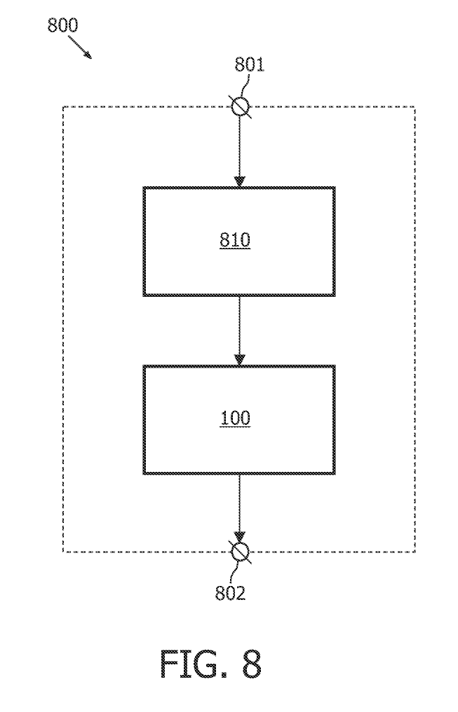

FIG. 8 schematically shows an exemplary embodiment of the image acquisition apparatus 800 that uses the system 100, said image acquisition apparatus 800 comprising an image acquisition unit 810 connected to the system 100 via an internal connection, an input connector 801, and an output connector 802. This arrangement advantageously increases the capabilities of the image acquisition apparatus 800, providing said image acquisition apparatus 800 with advantageous capabilities of the system 100 for segmenting an object in an image dataset. Examples of image acquisition apparatuses comprise, but are not limited to, a CT system, an X-ray system, an MRI system, a US system, a PET system, a SPECT system, and an NM system.

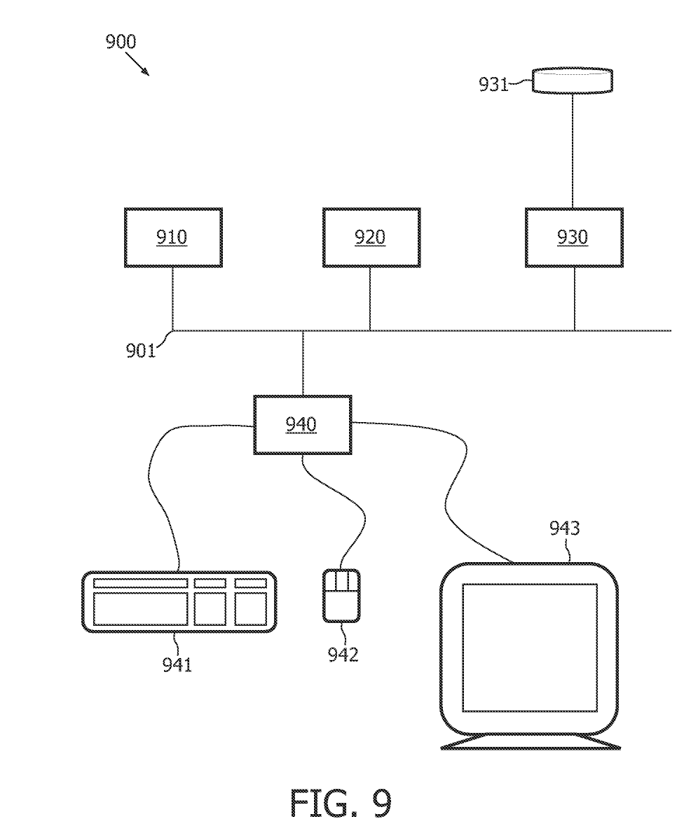

FIG. 9 schematically shows an exemplary embodiment of the workstation 900. The workstation comprises a system bus 901. A processor 910, a memory 920, a disk input/output (I/O) adapter 930, and a user interface (UI) 940 are operatively connected to the system bus 901. A disk storage device 931 is operatively coupled to the disk I/O adapter 930. A keyboard 941, a mouse 942, and a display 943 are operatively coupled to the UI 940. The system 100 of the invention, implemented as a computer program, is stored in the disk storage device 931. The workstation 900 is arranged to load the program and input data into the memory 920, and execute the program on the processor 910. The user can input information to the workstation 900 using the keyboard 941 and/or the mouse 942. The workstation is arranged to output information to the display device 943 and/or to the disk 931. Those skilled in the art will understand that there are numerous other embodiments of the workstation 900 known in the art and that the present embodiment serves the purpose of illustrating the invention and should not be interpreted as limiting the invention to this particular embodiment.

It should be noted that the above-mentioned embodiments illustrate rather than limit the invention and that those skilled in the art will be able to design alternative embodiments without departing from the scope of the appended claims. In the claims, any reference signs placed between parentheses shall not be construed as limiting the claim. The word “comprising” does not exclude the presence of elements or steps not listed in a claim or in the description. The word “a” or “an” preceding an element does not exclude the presence of a plurality of such elements. The invention may be implemented by means of hardware comprising several distinct elements and by means of a programmed computer. In the system claims enumerating several units, several of these units can be embodied by one and the same item of hardware or software. The use of the words first, second, third, etc. does not indicate any particular sequence. These words are to be interpreted as names.

1. A system (100) for segmenting an image dataset based on a deformable model for modeling an object in the image dataset, utilizing a coarse mesh for adapting to the image dataset and a fine mesh for extracting detailed information from the image dataset, the system comprising:
an initialization unit (110) for initializing the coarse mesh in an image dataset space;
a construction unit (120) for constructing the fine mesh in the image dataset space based on the initialized coarse mesh;
a computation unit (130) for computing an internal force field on the coarse mesh and an external force field on the coarse mesh, wherein the external force is computed based on the constructed fine mesh and a scalar field of intensities; and
an adaptation unit (140) for adapting the coarse mesh to the object in the image dataset, using the computed internal force field and the computed external force field, thereby segmenting the image dataset.

2. A system (100) as claimed in claim 1, wherein the fine mesh is constructed on a basis of a subdivision scheme of the coarse mesh.

3. A system (100) as claimed in claim 2, wherein the coarse mesh is a simplex mesh.

4. A system (100) as claimed in claim 2, wherein the coarse mesh is a triangular mesh.

5. A system (100) as claimed in claim 1, further comprising a determination unit for determining a resolution of the fine mesh.

6. An image acquisition apparatus (800), comprising a system (100) as claimed in claim 1.

7. A workstation (900), comprising a system (100) as claimed in claim 1.

8. A method (200) of segmenting an image dataset based on a deformable model for modeling an object in the image dataset, utilizing a coarse mesh for adapting to the image dataset and a fine mesh for extracting detailed information from the image dataset, the method comprising:
an initialization step (210) for initializing the coarse mesh in an image dataset space;
a construction step (220) for constructing the fine mesh in the image dataset space based on the initialized coarse mesh;
a computation step (230) for computing an internal force field on the coarse mesh and an external force field on the coarse mesh, wherein the external force is computed based on the constructed fine mesh and a scalar field of intensities; and
an adaptation step (240) for adapting the coarse mesh to the object in the image dataset, using the computed internal force field and the computed external force field, thereby segmenting the image dataset.

9. A computer program product to be loaded by a computer arrangement and comprising instructions for segmenting an image dataset based on a deformable model for modeling an object in the image dataset, utilizing a coarse mesh for adapting to the image dataset and a fine mesh for extracting detailed information from the image dataset, the computer arrangement comprising a processing unit and a memory, which computer program product, after being loaded, provides said processing unit with a capability to carry out the steps of:
initializing the coarse mesh in an image dataset space;
constructing the fine mesh in the image dataset space based on the initialized coarse mesh;
computing an internal force field on the coarse mesh and an external force field on the coarse mesh, wherein the external force is computed based on the constructed fine mesh and a scalar field of intensities; and
adapting the coarse mesh to the object in the image dataset, using the computed internal force field and the computed external force field, thereby segmenting the image dataset.
